(19) United States
(12) Patent Application Publication
(10) Pub. No.: US 2018/0055023 A1
(43) Pub. Date: Mar. 1, 2018

(54) ERGONOMIC AND RECONFIGURABLE LANDING NET

(71) Applicant: Harry Evans, Lake Charles, LA (US)

(72) Inventor: Harry Evans, Lake Charles, LA (US)

(21) Appl. No.: 15/252,225

(22) Filed: Aug. 31, 2016

(51) Int. Cl. A01K 77/00; A01K 75/00; B25G 1/06; B25G 1/10

(52) U.S. Cl. CPC A01K 77/00; B25G 1/102; B25G 1/06; A01K 75/00

(57) ABSTRACT

An ergonomic and reconfigurable landing net includes a horizontal handle and sling, which uniquely shifts weight placed on the landing net by a netted fish, such that excessive force is not placed on the user's wrist, as with traditional landing nets. The horizontal handle provides greater directional control over the net head and is adjustable, allowing the handle to be positioned in accordance with a user's physical attributes and/or needs. The landing net also includes a removable net head that allows the landing net to be reconfigured with net heads of varying shapes and sizes.

### FIELD

This disclosure relates to a unique fishing net, and more particularly to an ergonomically designed and reconfigurable fish landing net.

### BACKGROUND

While the need to capture fish as a means of survival has diminished in most parts of the world, pole fishing remains widely popular with sportsman, vacationers, and nature enthusiasts. Unlike food-source fishing, those who engage in pole fishing most often do so for reasons other than, or in addition to consumption. Some choose to keep their catch for consumption purposes, but many prefer to catch and release. In either case, the tools, mechanics, and methods for pole fishing are fairly universal.

Whether used to ensure that a hooked fish does not break free prematurely or to minimize physical harm to the fish itself, small hand nets (i.e., landing nets) are often used to help transition a hooked fish from water to land. Absent the buoyancy of the water, fish are sometimes prone to escape a fishing line as they are pulled out of the water and the full weight of the fish is asserted against the hook. While a fish breaking free from a fishing line can be a disappointment to the fisher, it is also poses a danger to the fish itself, as it often tears away the hooked portion of the fish.

Many varieties of landing nets are commercially available, varying in pole length, weight, net size, shape, etc. Landing nets are generally handheld, allowing the user to maneuver the net into position just under the fish and direct the catch to land or boat deck. Gripping the net, which is similar to the grip required to swing a tennis racket, requires the user to utilize wrist strength to appropriately position the net in water and then to draw in or lift a netted catch.

A number of factors can negatively influence effective use of a landing net including, for example, the physical attributes and muscular strength of the user. For example, a sufferer of arthritis affecting bone joints in the arm and hand, would likely find it difficult if not impossible to effectively maneuver a typical landing net. Also, rain and cold temperatures can negatively impact a user's ability to securely grip and hold a landing net. Moreover, a particularly heavy fish or awkward netting angle can make it difficult for even a physically fit fisherman to draw in a catch.

For at least the reasons set forth above, there is a need for an ergonomically designed landing net that lessons the physical force that is typically required for effective net use. A landing net is needed that minimalizes the need for excessive hand strength and healthy bone joint motion. More particularly, there is a need for a landing net, having a design that leverages stronger or less burdened body parts in order to assist or compensate for the excessive force that is typically placed on a user's hands and wrists. The design should further be easily reconfigurable, such that appropriately sized and shaped net heads may be applied based on particular environmental, geographical, or physical variables.

### SUMMARY

In the view of the foregoing disadvantages inherent in the known functional designs of handheld fishing nets (i.e., landing nets), an improved ergonomic and reconfigurable landing net is herein disclosed. Those of ordinary skill in the art will appreciate that the unique aspects for the disclosed landing net apply primarily to the manner of interface between the user and the landing net. However, other aspects disclosed herein, may alone or in combination represent further unique embodiments.

Moreover, while the unique features of the disclosed landing net are generally described relative to lessening the physical burdens or requirements for effective operation of the landing net, other advantages are contemplated. Such additional advantages, which may be implemented with minimal modification to the landing net as disclosed, will be appreciated by those of ordinary skill in the art and such modifications do not depart from the scope of the invention.

An ergonomic landing net comprises an elongated frame first side, an elongated frame second side, a sling having a first end secured to the elongated frame first side and an opposing second end attached to the elongated frame second side, and a handle positioned perpendicular to the elongated frame first side and the elongated frame second side. The ergonomic landing net also includes a net head assembly having a pole affixed to a net frame, wherein the net head assembly is secured between the elongated frame first side and the elongated frame second side.

In various embodiments, the elongated frame first side or the elongated frame second side comprises aluminum tubing. In one embodiment, the sling is manufactured from at least one of: cotton canvas, glass weave, plastic weave, or polymer weave. The sling may form a complete loop or may include a single length extending between the elongated frame first side and the elongated frame second side.

In various embodiment, the handle comprises a cylinder having a handle first end and a handle second end. The handle first end is secured to the elongated frame first end and the handle second end is secured to the elongated frame second side. The Handle is adjustably secured to the elongated frame first side and the elongated frame second side.

In various embodiments, the net head assembly includes a net head and is adjustably secured to the elongated frame first side and the elongated frame second side. The net head assembly is removably secured between the elongated frame first side and the elongated frame second side.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

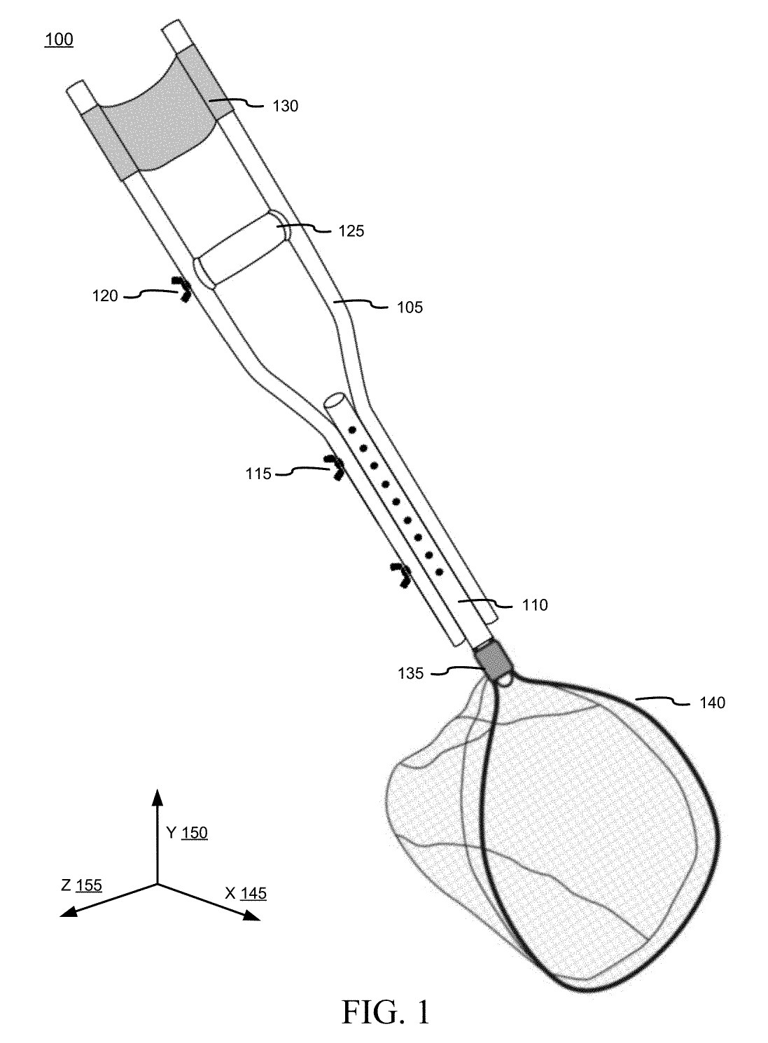

FIG. 1 illustrates a perspective view an exemplary ergonomic landing net, in accordance with various embodiments;

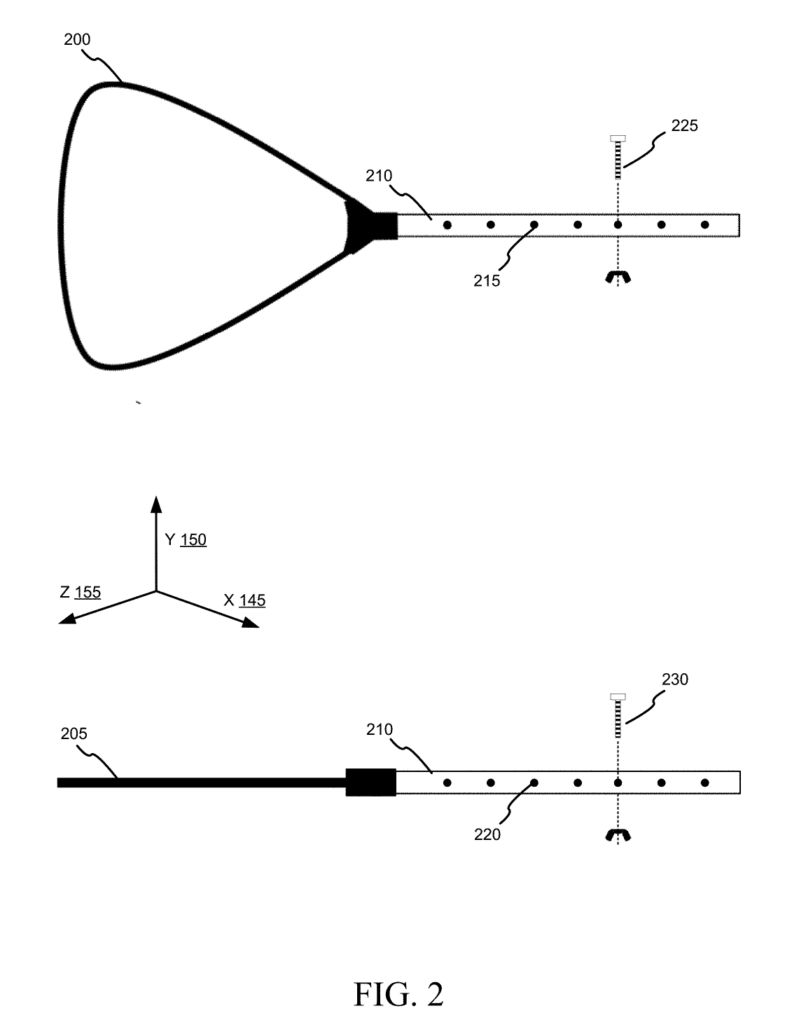

FIG. 2 illustrates an interchangeable net head for reconfiguring an exemplary ergonomic landing net, in accordance with various embodiments; and

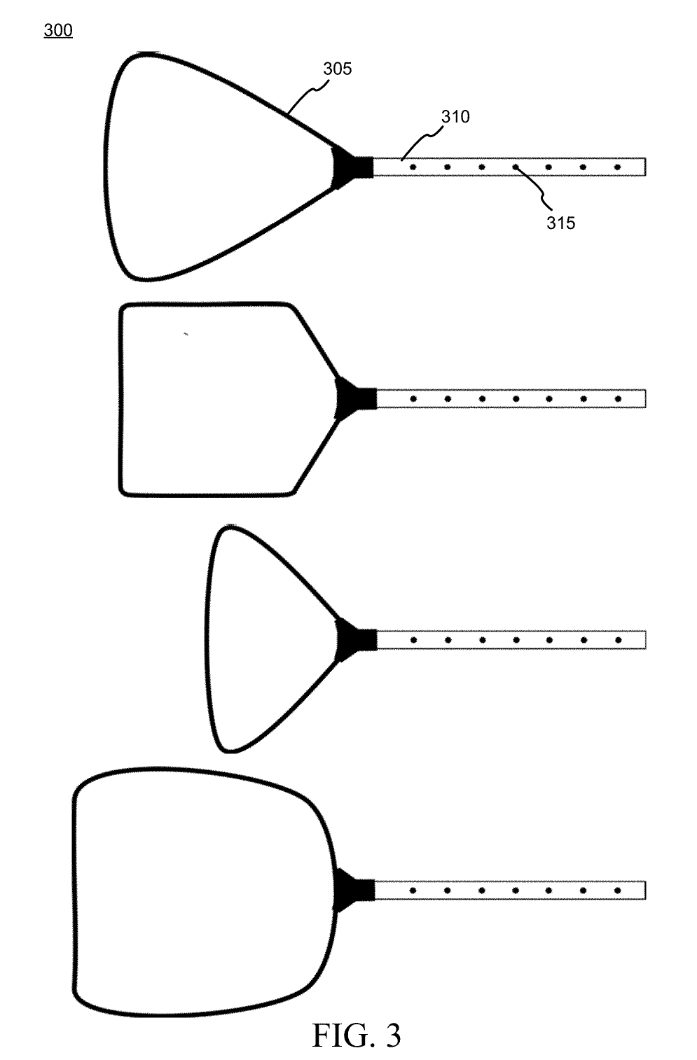

FIG. 3 illustrates example interchangeable net heads for reconfiguring an exemplary ergonomic landing net, in accordance with the present invention.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the disclosed ergonomic landing net is configured to shift and equitably distribute weight and shock across various points of the user's hand and arm. As will be described herein, the ergonomic and reconfigurable landing net includes unique design features, which functionally impact the usability and effectiveness of the landing net. While described herein in reference to a net, those of ordinary skill in the art will appreciate that similar design features may be applied to other known implements including, for example, a fishing pole.

The ergonomic and reconfigurable landing net is described relative to the corresponding figures. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

FIG. 1 illustrates a perspective view an exemplary ergonomic landing net, in accordance with various embodiments. For simplicity, the ergonomic and reconfigurable fishing net will be referenced as a “landing net.” If needed to differentiate from known prior art landing nets, use in such terms will be appropriately noted.

In various embodiments, the landing net 100 includes a frame 105 that is manufactured from lightweight metal (e.g., aluminum), a plastic, composites (e.g., fiberglass, carbon fiber), or other resin based material. The frame 105 may comprise two equal but opposing tubular portions that are joined by an arm sling 130, hand grip 125, and interchangeable net head 110.

The arm sling 130 comprises a flexible and durable fabric material such as a cotton-based canvas, woven glass yarn, polyester, and the like. When held in a netting position, the arm sling 130 rests against the user's forearm to stabilize a deployed landing net 100 along the X axis 145.

In one embodiment, the sling 130 is a single length of fabric that rests against one side of the forearm, leaving the other side of the forearm uncovered. In another embodiment, the sling 130 forms a loop, which wraps around the circumference of the user's forearm. As such, the user may slip an arm through the sling 130 loop to engage the landing net 100. In yet another embodiment, the sling 130 comprises a loop that may be opened and closed, such that the user wraps two opposing ends of the sling 130 around the forearm area and secures the two ends by way of a Velcro fastener, buckle, strap, etc.

When the landing net 100 is engaged, the handle 125 provides stability and motion control primarily along the Z axis 155 and the Y axis 150. Because the sling 130 allows redistribution of much of the load along the X axis 145, the handle 125 is relied upon less to invoke movement along the X axis 145 in one (single-sided sling 130 embodiment) or both opposing directions (looped sling 130 embodiment).

In various embodiments, the handle 125 is manufactured from a soft plastic, rubber, or urethane. To appropriately fit the landing net to the specific user, the handle 120 is adjustable. A bolt or pin passes through the center of the handle 125 in the direction of Z 155 and is held in place by a key or wingnut 120, which allows the handle to be conveniently removed or adjusted.

In various embodiments, the handle 120 may be moved up and down to comfortable fit the user. Each side component of the frame 105 includes a number of parallel through-holes positioned along the Y axis 150, thereby allowing the handle 125 to be repositioned within the frame 105 and secured by way of a bolt and wingnut 120.

The overall length, or reach, of the landing net 100 may be adjusted by way of a removable net head assembly 110. Similar to the handle 125, the net head assembly 110 is secured to the frame 105 by way of two or more bolts and two or more wingnuts 115. In various embodiments, the net head assembly 110 is maintained within the frame 105 by way of a pin and key or by any other means known in the art. A series of through-holes are aligned in a parallel configuration over a length of the net head assembly 110, allowing two or more bolts or pins to pass through the frame 105 and through the diameter of the net head assembly 110. A wingnut 115 or key may be used to secure the attachment between the frame 105 and net head assembly 110.

In various embodiments, the net head assembly 110 includes a chuck or threaded cuff 135 that allows for removal of the net frame 140 from the net head assembly 110. As such, a damaged net frame 140 may be replaced without requiring replacement of the entire net head assembly 110. In another embodiment, the net frame 140 and the net head assembly 110 are permanently affixed.

FIG. 2 illustrates an interchangeable net head for reconfiguring an exemplary ergonomic landing net, in accordance with various embodiments. In accordance with removable and adjustable net head embodiments, a net head assembly 200 comprises an extender 210 with a series of equally spaced through-holes 215 positioned along a length of the extender 210. The extender 210 may be manufactured from any durable material having a high tensile strength. Such material may include, for example, wood, plastic, polymer, fiberglass, carbon fiber, or aluminum.

In various embodiments, the net head assembly 200 includes a net frame, which may be available in different shape and size configurations. The extender 210 through holes 215 are positioned such that when engaged within the frame 105, the mouth of the net head 200 is open along the Z axis 155. The net head assembly 210 is positioned and secured to the frame 105 by way of one or more bolts 225 or pins.

In various embodiments, a net head assembly 205 includes an extender 210 having a plurality of through holes 220, such that when engaged within the frame 105, the mouth of the net head is open on the X axis 155. Accordingly, the extender 210 of the net head assembly 205 may be variously positioned within the frame 105 in order to increase or decrease the landing net reach. As those of ordinary skill in the art will appreciate, “reach” is used herein to denote the functional length of the landing net 100 when engaged and in use by a user. To affix the extender 210 of the net head assembly 205 within a desired position within the frame 105, one or more bolts 230 or pins are threaded through a first frame through hole, then through the extender 210, and finally through a second frame through hole. The bolt 230 or pin may be secured and locked into place by an appropriately sized nut or key.

FIG. 3 illustrates example interchangeable net heads for reconfiguring an exemplary ergonomic landing net, in accordance with the present invention. To suite variances in water depth, obstacles, netting angles, fish size, user physical attributes, and the like; a number of net head assembly 300 configurations may be made available. An interchangeable net head assembly 300 comprises a net head assembly pole 315 that is configured with bolt or pin through holes 315 for securing the net head assembly 300 to the frame 105. The interchangeable net head 300 embodiment allows variable net 305 configurations to be used without requiring replacement of the entire landing net.

It is to be understood that the above description is intended to be illustrative, and not restrictive. For example, the above-discussed embodiments may be used in combination with each other. Many other embodiments will be apparent to those of skill in the art upon reviewing the above description.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An ergonomic landing net comprising:
an elongated frame first side;
an elongated frame second side;
a sling having a first end secured to the elongated frame first side and an opposing second end secured to the elongated frame second side;
a handle positioned perpendicular to the elongated frame first side and the elongated frame second side; and
a net head assembly having an extender portion affixed to a net frame, wherein the extender portion is secured between the elongated frame first side and the elongated frame second side.

2. The ergonomic landing net of claim 1, wherein at least one of: the elongated frame first side or the elongated frame second side comprises aluminum tubing.

3. The ergonomic landing net of claim 1, wherein the sling is manufactured from at least one of: cotton canvas, glass weave, plastic weave, or polymer weave.

4. The ergonomic landing net of claim 1, wherein the sling forms a complete loop

5. The ergonomic landing net of claim 1, wherein the sling includes a single length extending between the elongated frame first side and the elongated frame second side.

6. The ergonomic landing net of claim 1, wherein the handle comprises a padded cylinder.

7. The ergonomic landing net of claim 1, wherein the sling comprises a first loop side and a second loop side, the first loop side being affixed to the elongated frame first side and the second loop side being affixed to the elongated frame second side.

8. The ergonomic landing net of claim 7, wherein the handle first end is secured to the elongated frame first end and the handle second end is secured to the elongated frame second side.

9. The ergonomic landing net of claim 1, wherein the handle is adjustably secured to the elongated frame first side and the elongated frame second side.

10. The ergonomic landing net of claim 1, wherein the net head assembly includes a net head.

11. The ergonomic landing net of claim 1, wherein the net head assembly is adjustably secured to the elongated frame first side and the elongated frame second side.

12. The ergonomic landing net of claim 1, wherein the net head assembly is removably secured between the elongated frame first side and the elongated frame second side.
